(19) United States
(12) Patent Application Publication
(10) Pub. No.: US 2007/0114766 A1
(43) Pub. Date: May 24, 2007

(54) Structure of front pillar trim of curtain air bag

(75) Inventor: Min Ho Hwang, Gyeonggi-do (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 11/301,961

(22) Filed: Dec. 12, 2005

(30) Foreign Application Priority Data
Nov. 22, 2005 (KR) 2005-0111763

(51) Int. Cl. B60R 21/213; B60R 21/215; B60R 13/01

(52) U.S. Cl. 280/730.2; 280/728.3; 296/39.1

(57) ABSTRACT

A structure of a front pillar trim of a curtain air bag is disclosed. In a preferred system, in order to smoothly unfold, a part where the front pillar trim is installed when the curtain air bag is unfolded into the passenger compartment of a vehicle, a mounting boss is installed in a mounting hole of the front pillar trim to prevent the front pillar trim from separating and to spread the front pillar trim sufficient to unfold the curtain air bag.

The present invention claims priority from Korean patent application no. 2005-0111763 filed Nov. 22, 2005, which is incorporated by reference herein in its entirety.

### BACKGROUND OF THE INVENTION

1. Field of the Invention

The present invention relates to a structure of a front pillar trim of a curtain air bag in which, in order to smoothly unfold a part where the front pillar trim is installed when the curtain air bag is unfolded into the passenger compartment of a vehicle, a mounting boss is installed in a mounting hole of the front pillar trim to prevent the front pillar trim from separating and to spread the front pillar trim sufficient to unfold the curtain air bag.

2. Description of the Related Art

Generally, an air bag system is a safety device operating such that a sensor installed in a vehicle frame detects shock from a vehicle's collision and transmits the detected shock to a microcomputer, the microcomputer determines whether an air bag will be unfolded or not according to intensity of the shock, if the shock is sufficient to unfold the air bag, the microcomputer transmits an electric signal to an inflator, and the inflator then bums a gas generating material to expand the air bag for the purpose of protecting a passenger.

The air bag is a device for protecting a passenger by preventing the passenger's head and/or chest from secondarily colliding against a steering wheel and/or a windscreen glass. Although being different according to collision types and collision speed of a vehicle, the air bag must be expanded within a very short time, because a time from the collision to the determination of the collision is generally 10 ms, and a time from the output of the electric signal to full expansion of the air bag is 30 ms to 40 ms.

The air bag system requires a high reliability because the air bag system must be expanded without fail when a traffic accident occurs, and on the contrary, must not be activated otherwise.

Moreover, in the case of side impact collision of a vehicle, a roof side rail is acutely deformed and pushed deep into the compartment of the vehicle. Due to this, the passenger's body, particularly a passenger's head may be seriously damaged. In order to prevent the damage, a curtain air bag is installed along the side of a roof liner of the vehicle.

The curtain air bag is activated such that a front pillar trim is not separated when unfolding the curtain air bag. According to the conventional curtain air bag, in order to prevent the front pillar trim from separating when the conventional curtain air bag unfolds, the front pillar trim is mounted on the frame of the vehicle using bolts.

However, according to the conventional structure to prevent separation of the front pillar trim, since the front pillar trim is not spaced apart outwardly and does not spread when the conventional curtain air bag installed in a vehicle is actually unfolded, the smooth unfolding of the conventional curtain air bag is interrupted or the front pillar trim is separated from the vehicle frame potentially increasing damage to the passengers in the vehicle.

There are proposals such as a structure of forming notches in the front pillar trim and a structure in which a pin member is coupled with the front pillar trim and a grommet member is coupled with the front pillar such that the pin member is inserted into the grommet member, resulting in the pin member separating from the grommet member when the conventional curtain air bag is unfolded so that the front pillar him spreads.

However, the above-described structures have disadvantages that there are many components and complicated manufacturing processes such that the pin member is coupled with the front pillar trim, the grommet member is coupled with the front pillar trim, and then the pin member is coupled with the grommet member.

The information set forth in this Background of the Invention section is only for enhancement of understanding of the invention and should not be taken as an acknowledgement or any form of suggestion that this information forms the prior art that is already known to a person skilled in the art.

### SUMMARY OF THE INVENTION

Therefore, the present invention has been made in view of the above problems, and it is an object of the present invention to provide a structure of a front pillar trim of a curtain air bag in which the number of components and manufacturing process are reduced, and a mounting boss is installed to spread the front pillar trim at a distance in which the curtain air bag can be smoothly unfolded.

In accordance with the present invention, the above and other objects can be accomplished by the provision of a structure of a front pillar trim of a curtain air bag including a front pillar trim activated by the curtain air bag and having a mounting hole through which the front pillar trim is coupled with a frame panel of a vehicle, and a mounting boss including a body making surface contact with an inner surface of an end of the mounting hole, and structured such that a side of the front pillar trim spreads at a distance where the curtain air bag can be unfolded

Preferably, the mounting boss includes an insertion hole formed in the body such that a fastening bolt is fastened there into, and a locking part formed in an outer circumference of the body.

The locking part includes a first locking part stepped at the outer side of a leading edge of the body, and a second locking part spaced apart from the first locking part and formed in the rear side of the body.

The first locking part has a rounded outer end and the second locking part is bent toward the outer side of the body in the vertical direction.

The invention also includes vehicles that comprise one or more of a structure of a front pillar trim of a curtain air bag as described herein.

It is understood that the term “vehicle” or “vehicular” or other similar terms as used herein is inclusive of motor vehicles in general such as passenger automobiles including sports utility vehicles (SUV), buses, trucks, various commercial vehicles, and the like.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a structure of a front pillar trim of a curtain air bag according to a preferred embodiment of the present invention;

FIG. 2 is a sectional view illustrating the structure of the front pillar trim of a curtain air bag according to the preferred embodiment of the present invention; and

FIGS. 3a to 3c are views illustrating operation of the structure of the pillar trim of a curtain air bag according to the preferred embodiment of the present invention.

### DESCRIPTION OF THE PREFERRED EMBODIMENTS

As discussed above, a structure of a front pillar trim of a curtain air bag is provided which suitably comprises a front pillar trim activated by the curtain air bag and having a mounting aperture through which the front pillar trim is coupled with a frame panel of a vehicle; and a mounting boss comprising a body in communication of the mounting aperture. Preferably, the structure is configured such that a side of the front pillar trim spreads at a distance where the curtain air bag can be unfolded.

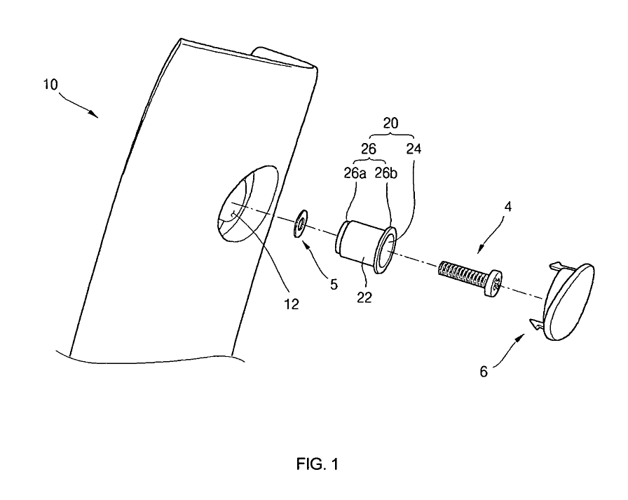

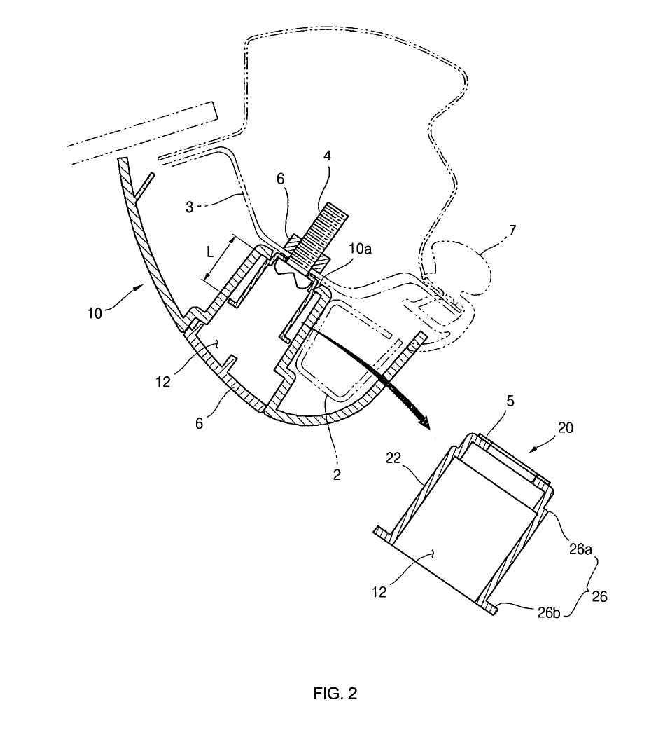

FIG. 1 is a view illustrating a structure of a front pillar trim of a curtain air bag according to a preferred embodiment of the present invention, and FIG. 2 is a sectional view illustrating the structure of the front pillar trim of a curtain air bag according to the preferred embodiment of the present invention.

Referring to FIGS. 1 and 2, the front pillar trim 10 is activated by a curtain air bag 2 and has a mounting hole 12 for allowing the front pillar trim 10 to be coupled with a frame panel 3 of a vehicle.

The front pillar trim 10 includes a mounting boss 20 having a body 22 making surface contact with the inner surface of an end of the mounting hole 12. According to the structure of the front pillar trim of the curtain air bag, the mounting boss 20 is structured such that a side of the front pillar trim 10 spreads at a distance where the curtain air bag 2 is smoothly unfolded.

The mounting boss 20 has an insertion hole 24 formed in the body 22 into which a fastening bolt 4 is fastened and a locking part 26 formed in an outer circumference of the body 22.

The mounting boss 20 is preferably made of metal. This is to prevent the mounting boss 20 from breaking or cutting off when the mounting boss 20 makes surface contact with the front pillar trim 10 and slides due to the operation of the curtain air bag 2.

The locking part 26 includes a first locking part 26a stepped in the outer side of the leading edge of the body 22. The first locking part 26a has a rounded outer end.

A second locking part 26b is spaced apart from the first locking part 26a and is formed in a rear end of the body 22. The second locking part 26b is bent toward the outside of the body 22 in the vertical direction.

The body 22 has a horizontal sliding length L between the first locking part 26a and the second locking part 26b.

The sliding length L means a length where the front pillar trim 10 makes surface contact with the body 22 and slides between the first locking part 26a and the second locking part 26b, and corresponds to the distance where the front pillar trim 10 is separated from a door weather strip 7 and spreads as far as the sliding length L.

The mounting boss 20 is installed with a washer 5 between the frame panel 2 of the vehicle and the insertion hole 24 to prevent the fastening bolt 4 from separating. The fastening bolt 4 is fastened into a nut 6 installed in the frame panel 3 of the vehicle.

The front pillar trim 10 includes an inclination 10a inclined toward inside the end of the mounting hole 12.

The operation of the front pillar trim of a curtain air bag according to the preferred embodiment of the present invention will be described.

When a side impact collision occurs or a vehicle is overturned when the vehicle is traveling, the sensor (not shown) of the vehicle detects the side impact collision and transmits a collision signal to a controller (not shown).

If the signal for the side impact collision transmitted to the controller corresponds to a condition to activate the curtain air bag installed in the vehicle, the inflator (not shown) installed in the vehicle is activated such that a propellant gas is supplied to unfold the curtain air bag into the passenger compartment of the vehicle.

As such, due to the propellant gas, the curtain air bag is expanded to push a headlining (not shown) outward and is unfolded into the passenger compartment of the vehicle, and the curtain air bag and the front pillar trim are operated in the region where the front pillar trim is installed as follows.

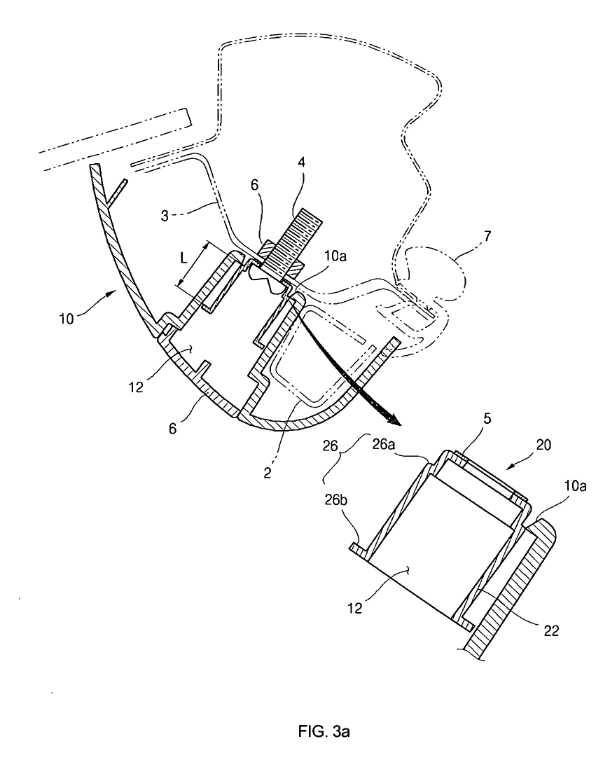

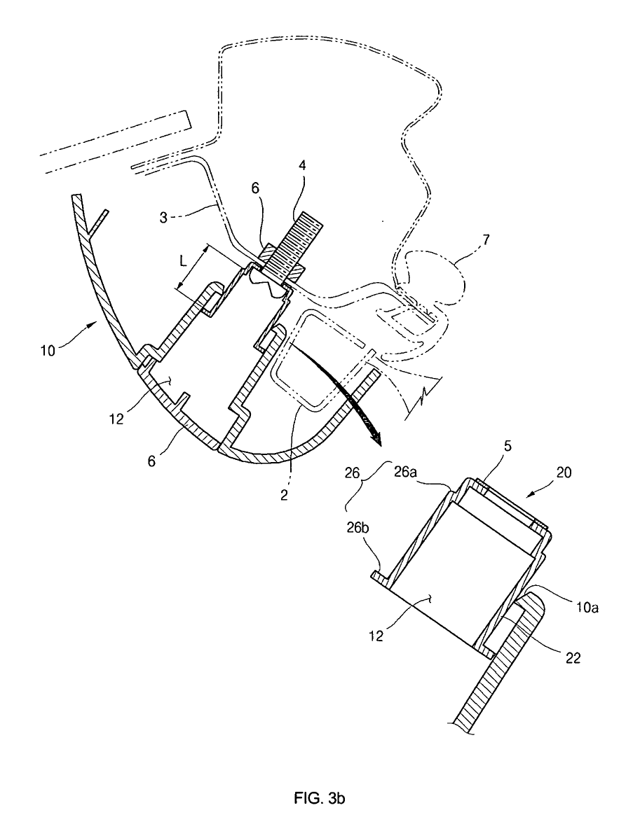

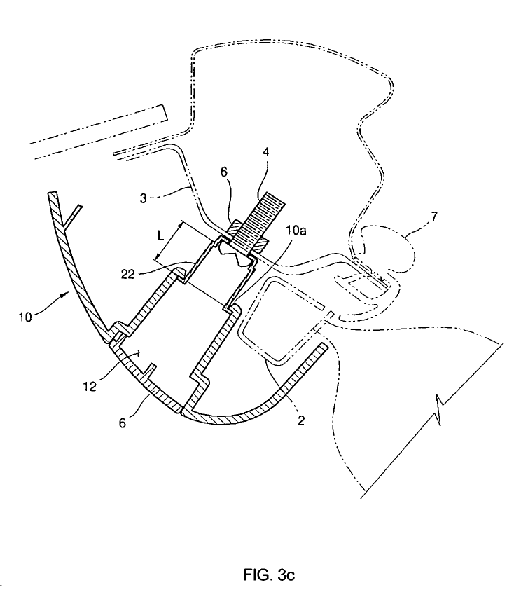

Referring to FIG. 3a, due to the activation of the curtain air bag 2, the front pillar trim 10 receives an expansive force from the curtain air bag 2 and the expansive force is transmitted to the front pillar trim 10.

The inclination 10a of the front pillar trim 10 is supported by the first locking part 26a formed in the locking part 26 of the mounting boss 20 before the curtain air bag 2 is activated, and the inclination 10a makes surface contact with the mounting boss 20 and starts to slide when the expansive force of the curtain air bag 2 is applied thereto.

During the sliding of the front pillar trim 10, the fastening bolt 4 installed in the insertion hole 24 of the mounting boss 20 stays fixed in the frame panel 3 of the vehicle.

When the front pillar trim 10 slides, the first locking part 26a makes the surface contact with the inclination 10a of the front pillar trim 10 and slides thereon.

As shown in an enlarged view, since the first locking part 26a has a rounded outer step, the first locking part 26a makes surface contact with the outer circumference of the mounting boss 20 and smoothly slides thereon.

At the same time, the side of the front pillar trim 10 starts to spread minutely and to be separated from the door weather strip 7.

With reference to FIG. 3b, the front pillar trim 10 further slides in the state shown in FIG. 3a and passes through the first locking part 26a to slide toward the second locking part 26b along the outer circumference of the body 22.

As the process described above progresses, the distance between the door weather strip 7 and the front pillar trim 10 becomes larger, and the curtain air bag 2 starts to be unfolded into the passenger compartment of the vehicle through the widened gap.

Referring to FIG. 3c, when the front pillar trim 10 slides in the state depicted in FIG. 3b and the inclination 10a of the front pillar trim 10 is locked by the second locking part 26b, the sliding of the front pillar trim 10 is stopped.

Since the second locking part 26b is bent toward the outer side of the body 22 in the vertical direction, the front pillar trim 10 does not slide further.

Simultaneously, as the side of the front pillar trim 10 is separated from the door weather strip 7, the curtain air bag 2 is smoothly unfolded into the widened gap.

Since the body 22 has the horizontal sliding length L formed between the first locking part 26a and the second locking part 26b, the front pillar trim 10 is separated from the door weather strip 7 as far as the sliding length L so that the curtain air bag 2 is unfolded.

Although the sliding length L is not specified, the sliding length L has a sufficient length allowing the curtain air bag 2 to be smoothly unfolded into the passenger compartment of a vehicle.

As described above, in the structure of the front pillar trim of the curtain air bag according to the present invention, the conventional clip mounting is omitted and the front pillar trim smoothly spreads when the curtain air bag is unfolded.

Moreover, since the clip mounting is not required in a vehicle assembling line, the manufacturing process is reduced and workability is enhanced.

Additionally, since the curtain air bag is smoothly unfolded into the passenger compartment when the structure of the front pillar trim of a curtain air bag according to the present invention is actually installed in a vehicle, a passenger's injuries caused by a traffic accident can be minimized.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A structure of a front pillar trim of a curtain air bag comprising:
a front pillar trim activated by the curtain air bag and having a mounting hole through which the front pillar trim is coupled with a frame panel of a vehicle; and
a mounting boss including a body making surface contact with an inner surface of an end of the mounting hole, and structured such that a side of the front pillar trim spreads at a distance where the curtain air bag can be unfolded.

2. The structure of a front pillar trim of a curtain air bag as set forth in claim 1, wherein the mounting boss comprises:
an insertion hole formed in the body such that a fastening bolt is fastened there into; and
a locking part formed in an outer circumference of the body.

3. The structure of a front pillar trim of a curtain air bag as set forth in claim 2, wherein the locking part comprises:
a first locking part stepped at the outer side of a leading edge of the body; and
a second locking part spaced apart from the first locking part and formed in the rear side of the body.

4. The structure of a front pillar trim of a curtain air bag as set forth in claim 3, wherein the second locking part is bent toward the outer side of the body in the vertical direction.

5. The structure of a front pillar trim of a curtain air bag as set forth in claim 1, wherein the body includes a horizontal sliding length formed between the first locking part and the second locking part.

6. The structure of a front pillar trim of a curtain air bag as set forth in claim 2, wherein the mounting boss includes a washer installed between the frame panel of the vehicle and the insertion hole to prevent the fastening bolt from separating.

7. The structure of a front pillar trim of a curtain air bag as set forth in claim 1, wherein the front pillar trim comprises an inclination inclined toward inside the end of the mounting hole.

8. The structure of a front pillar trim of a curtain air bag as set forth in claim 3, wherein the body includes a horizontal sliding length formed between the first locking part and the second locking part.

9. A structure of a front pillar trim of a curtain air bag comprising:
a front pillar trim activated by the curtain air bag and having a mounting aperture through which the front pillar trim is coupled with a frame panel of a vehicle; and
a mounting boss comprising a body in communication of the mounting aperture.

10. The structure of claim 9 wherein the structure is configured such that a side of the front pillar trim spreads at a distance where the curtain air bag can be unfolded.

11. A vehicle comprising the structure of claim 1.

12. A vehicle comprising the structure of claim 9.
